(19) United States
(12) Patent Application Publication
(10) Pub. No.: US 2003/0232533 A1
(43) Pub. Date: Dec. 18, 2003

(54) Plug connector comprising a movable plug piece receptacle

(75) Inventor: Michael Burmeister, Minden (DE)

Correspondence Address: Norman P. Soloway, HAYES SOLOWAY P.C., 130 W. Cushing Street, Tucson, AZ, 85701, US

(73) Assignee: HARTING Electro-Optics GmbH & Co. KG

(21) Appl. No.: 10/462,441

(22) Filed: Jun. 16, 2003

(30) Foreign Application Priority Data
Jun. 18, 2002 (DE) 102 27 156.9

(51) Int. Cl. H01R 13/15

(52) U.S. Cl. 439/259

(57) ABSTRACT

A plug socket comprises a housing, a plug piece receptacle made of an insulating material and arranged in the housing such that it can be moved between an initial position and a plug-in position. The plug socket further includes a plurality of contact elements which serve for making contact with a plug piece inserted in the receptacle and are provided on the plug piece receptacle, and at least one spring which urges the plug piece receptacle into the initial position.

### TECHNICAL FIELD

The invention relates to a plug socket into which a complementary plug piece can be inserted in order to establish a plug connection.

### BACKGROUND OF THE INVENTION

With all plug connections there basically is the problem that on the one hand during inserting the plug piece in the plug socket it has to be ensured that the plug piece is properly aligned in relation to the plug socket, or tht measures are taken which allow to have tolerances balanced. Otherwise it can not be guaranteed that the conductors to be connected are contacted properly. The problem of misalignment is the more severe the more contacts have to be plugged together and the narrower the spacing is between these contacts. Especially in case the plug piece is a circuit board provided with a multiplicity of conductor tracks arranged close to each other, it is of particular importance that these conductor tracks are contacted with positional accuracy.

It is the object of the invention to provide a plug socket by means of which the conductors of a plug piece, in particular of a circuit board, can be contacted with high accuracy.

### BRIEF SUMMARY OF THE INVENTION

According to the invention, a plug socket comprises a housing. Arranged in the housing is a plug piece receptacle made of an insulating material, the receptacle being movable between an initial position and a plug-in position. The plug socket further includes a plurality of contact elements which serve for making contact with a plug piece inserted in the receptacle and are accommodated in the plug piece receptacle, and at least one spring which urges the plug piece receptacle into the initial position. As the plug piece receptacle is movable, it will be properly aligned during inserting the plug piece despite any positional tolerances, so that the contact elements arranged on the plug piece receptacle are able to make contact with the conductors of the plug piece associated thereto with positional accuracy.

According to a preferred embodiment provision is made that the plug piece receptacle has a rectangular cross section and the contact elements are arranged on one of the broader side walls of the plug piece receptacle. Such plug piece receptacle is particularly suitable for receiving a circuit board as the plug piece, which board can be pushed into the interior space of the plug piece receptacle with a very small clearance. In is arrangement, the contact elements are arranged such that they make contact with conductor tracks provided on the upper and lower sides of the circuit board.

It is preferably provided that the contact elements are movably arranged in the side wall of the plug piece receptacle, Tis measure likewise serves for balancing tolerances, namely in terms of the thickness of the plug piece; the contact elements will be forced outwards during inserting the plug piece and glide on the surface thereof until they make contact with the appropriate conductors. Contact balls, for instance, are particularly suitable for being used as contact elements, these balls being received in a bore in the side wall of the plug piece receptacle. Basically, all other contact elements are suited as well, for instance cylindrical contact elements or pins.

Here it is preferably provided that the contact elements are elastically urged towards the interior space of the plug piece receptacle. In this way the required contact force is ensured whilst at the same time it is possible to balance any tolerances that might exist.

According to the preferred embodiment of the invention it is provided that the spring urging the plug piece receptacle into the initial position also urges the contact elements towards the interior space of the plug piece receptacle. The result is a particularly simple construction with few components, because the spring has a dual function.

It is preferably provided that the spring is a U-type spring having an abutment end and a supporting end, the abutment end resting at the housing and the supporting end being supported by the contact elements, so that the latter are urged towards the interior space of the plug piece receptacle. It is in this way that the forces exerted on the spring by the contact elements are directly taken up by the housing.

According to the preferred embodiment of the invention it is provided that the spring is fastened to the plug piece receptacle, so that it is entrained by the plug piece receptacle when the latter is moved from the initial position into the plug-in position. This makes it possible during moving the plug piece receptacle to vary the force exerted on the contact elements by the spring. This may be effected, for example, in that the housing has an abutment face for the abutment end of the spring and that the abutment face extends obliquely in relation to the moving direction of the plug piece receptacle, so that the spring is increasingly bent when it is moved, together with the plug piece receptacle, from the initial position into the plug-in position. It is in this way that only small abutment forces will act during pushing the plug piece into the plug piece receptacle, so that the contact elements glide on the surface of the plug piece with low friction. It is not until the plug piece has been fully pushed into the plug piece receptacle and there is no relative motion any more between the plug piece and the plug piece receptacle that the contact force rises to the actually required value.

It is preferably provided that the abutment face, at its front end as seen in the moving direction of the plug piece receptacle, is provided with a recess which is engaged by the abutment end of the spring if the plug piece receptacle is in the initial position. The recess together with the abutment end of the spring makes sure that the initially required force to move the plug piece receptacle out of its initial position is larger than the force which is required for pushing the plug piece into the plug piece receptacle.

According to the preferred embodiment of the invention it is provided that a flexible conductor foil is arranged between the supporting end of the spring and the contact elements, the conductor foil being fastened to the plug piece receptacle and to the housing as well. A flexible conductor foil is particularly suited to establish the connection to the movably arranged plug piece receptacle, because the conductor foil can follow the shifting motion of the plug piece receptacle without any problems.

It is preferably provided that the interior space of the plug piece receptacle has an area, situated between the entrance port for the plug piece and the contact elements, which expands towards the entrance port in the nature of a pilot funnel. This measure facilitates the insertion of the plug piece in the plug piece receptacle.

According to the preferred embodiment of the invention two springs are provided so as to be arranged on opposite sides of the plug piece receptacle, and the plug piece receptacle is mounted between the springs in a floating manner. Any tolerances can be balance particularly well in this way. Moreover, it is not necessary to provide expensive guides for the plug piece receptacle.

### BRIEF DESCRIPTION OF THE DRAWINGS

FIG. 1 shows in a sectional view a plug socket, the plug piece receptacle being in the initial position;

FIG. 2 shows in a schematic, perspective view the plug piece receptacle of FIG. 1 and a plug piece;

FIG. 3 shows in a sectional view the plug socket of FIG. 1, with a plug piece inserted in the plug piece receptacle which still is in the initial position;

FIG. 4 shows in a sectional view the plug socket of FIG. 3, with the plug piece receptacle being in an intermediate position between its initial position and a plug-in position; and

FIG. 5 shows in a sectional view the plug socket of FIG. 4, with the plug piece fully inserted in the plug socket and the plug piece receptacle being in the plug-in position.

### DETAILED DESCRIPTION OF THE PREFERRED EMBODIMENTS

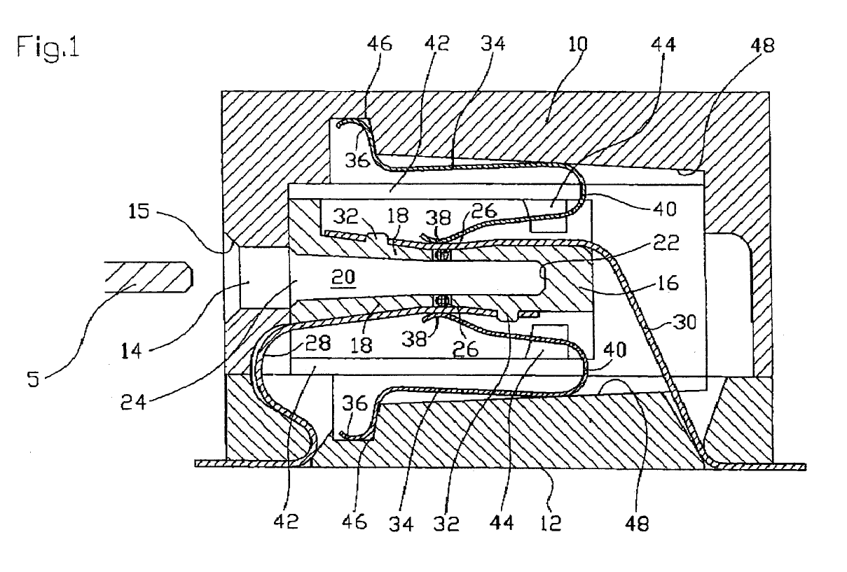

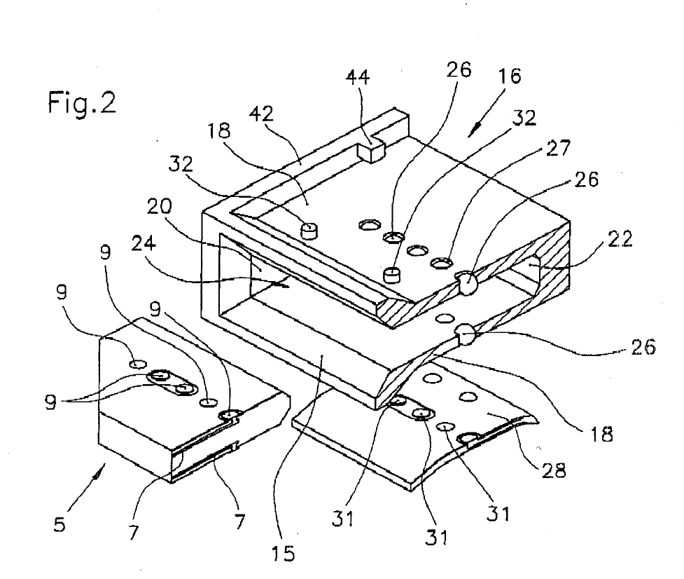

The construction of the plug socket will now be explained with the aid of FIGS. 1 and 2. The plug socket has a housing 10 which can be fastened to a suitable base by means of a mounting surface 12. Formed in the housing 10 is an aperture 14 through which a plug piece 5 can be pushed into the housing 10. The dimensions of the aperture 14 are larger than the dimensions of the plug piece 5. A pilot ramp 15 is additionally provided on the exterior.

In particular, the plug piece 5 can be a circuit board which is provided with several conductor tracks 7 (see in particular FIG. 2). In the plug piece 5 shown, the conductor tracks 7 are arranged inside and terminate at the surface in contact areas 9. Departing from the embodiment shown, the conductor tracks 7 could also extend on the surface of the circuit board.

A plug piece receptacle 16 is arranged in the interior of the housing. This receptacle is realized in the nature of a pocket with a rectangular cross section, i.e. has two broader side walls 18, two narrower side walls 20, a bottom 22 and an entrance port 24 opposite the bottom.

A plurality of contact elements 26 is arranged or accommodated in the broader side walls 18; in this case, the contact elements are realized as contact balls and made of an electrically conductive material. They preferably are coated with gold. The contact elements 26 are each arranged in a bore 27 which is narrowed towards the interior space of the plug piece receptacle 16 such that the corresponding contact element 26 can not come out of the bore 27 on this side.

The cross section and the dimensions of the interior space of the plug piece receptacle 16 correspond, in the area lying between the contact elements 26 and the bottom 22 of the plug piece receptacle, to the dimensions of the plug piece 5, so that the plug piece 5 is received in the plug piece receptacle 16 with small clearance. In the area of the interior space of the plug piece receptacle 16 lying between the contact elements 26 and the entrance port 24, the cross section of the interior space slightly expands towards the entrance port 24 such that there is produced a pilot funnel for the plug piece 5.

Two flexible conductor foils 28, 30 are arranged on the exterior of the broader side walls 18 of the plug piece receptacle 16, which each have several conductor tracks 31. Each conductor track is associated to one contact element 26. The conductor foil 28 is arranged on the lower side wall 18 with respect to FIG. 1 and extends in a loop first to the left wall of the housing 10 and from there in downward direction, where it comes out of the housing 10 in the region of the mounting surface 12. The conductor foil 30 is arranged on the upper side wall 18 of the plug piece receptacle 16 and from there extends to the right and obliquely downwards, likewise coming out of the housing 10 in the area of the mounting surface 12. Each conductor foil 28, 30 is fastened to the plug piece receptacle 16 by several fastening pins 32 formed on the exterior of the side walls 18 and engaging in corresponding openings of the conductor foils 28, 30.

Arranged between the side walls 18 of the plug piece receptacle 16 and the housing 10 is one spring 34 each. Each spring 34 is a U-type spring having an abutment end 36, a supporting end 38 and a bending section 40 therebetween. The supporting end 38 of each spring 34 rests on the conductor foil 28 and 30, respectively, in the area under which the contact elements 26 are arranged. Thus, the spring ensures that the conductor tracks of the conductor foil are pressed against the contact elements 26, so that an electrical contact is established.

The spring 34 is fastened to the plug piece receptacle 16 in its area lying between the supporting end 38 and the bending section 40. To this end, a laterally arranged web 42 in the plug piece receptacle (see in particular FIG. 2) is provided with a holding projection 44 engaging in a complementary lateral recess of the spring 34.

In the initial position shown in FIG. 1, the abutment end 36 of the spring 34 is situated in a recess 46 in each case; these recesses are formed in the housing 10 so as to be opposite each other. Each of the recesses 46 is followed by an abutment face 48 which starting from the recess 46 extends to the right regarding FIG. 1, i.e. away from the aperture 14 of the housing 10. The abutment faces 48 are inclined such that the spacing between them becomes smaller with increasing distance from aperture 14.

In the initial position shown in FIG. 1 the plug piece receptacle 16 is held in this initial position substantially only by the springs 34. In the initial position the entrance port 24 of the plug piece receptacle 16 immediately adjoins the aperture 14 in the housing 10. The plug piece 5 to be inserted in the plug socket is guided into the interior space of the plug piece receptacle 16 by the pilot ramps 15 of aperture 14 as well as by the pilot funnel formed in the plug piece receptacle 16.

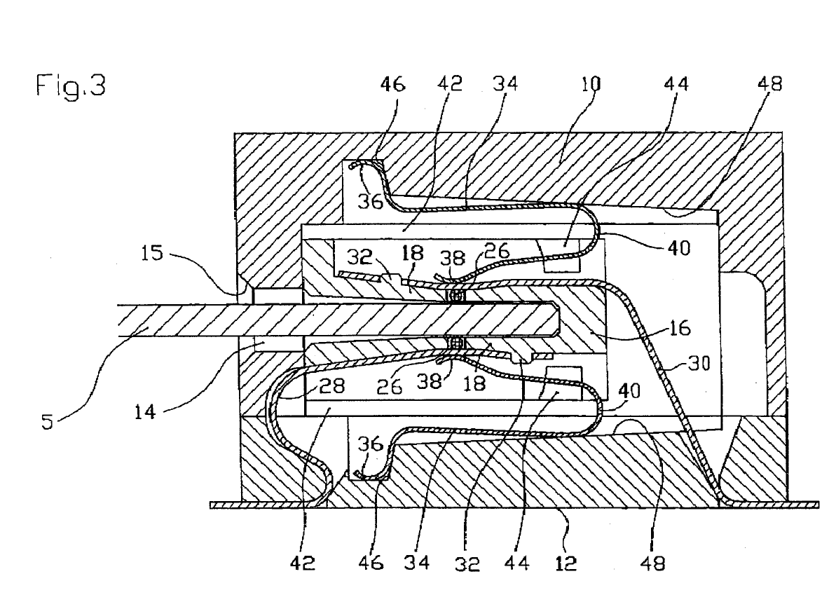

In the course of inserting the plug piece 5 in the plug piece receptacle 16, the abutment ends 36 engaging in the recesses 46 in the housing 10 ensure that the plug piece receptacle 16 is held in its initial position until the plug piece 5 is fully inserted in the plug piece receptacle 16 and rests at the bottom 22. The force tat would be required to move the springs 34 to the right regarding FIGS. 1 and 3 and, in so doing, to pull the abutment faces 36 out of the recesses 46, is in fact larger than the frictional force which during inserting the plug piece 5 is effective between the plug piece receptacle 16 and the plug piece, in particular between the plug piece 5 and the contact elements 26. As the plug piece receptacle 16 is mounted between the two springs 34 in a floating manner, it automatically assumes the optimal position during inserting the plug piece 5, so that even in case where the plug piece is inserted skewed in the housing the plug piece 5 will come to lie in the plug piece receptacle 16 in proper position and the contact areas 9 will be underneath the contact elements 26 in their accurate position.

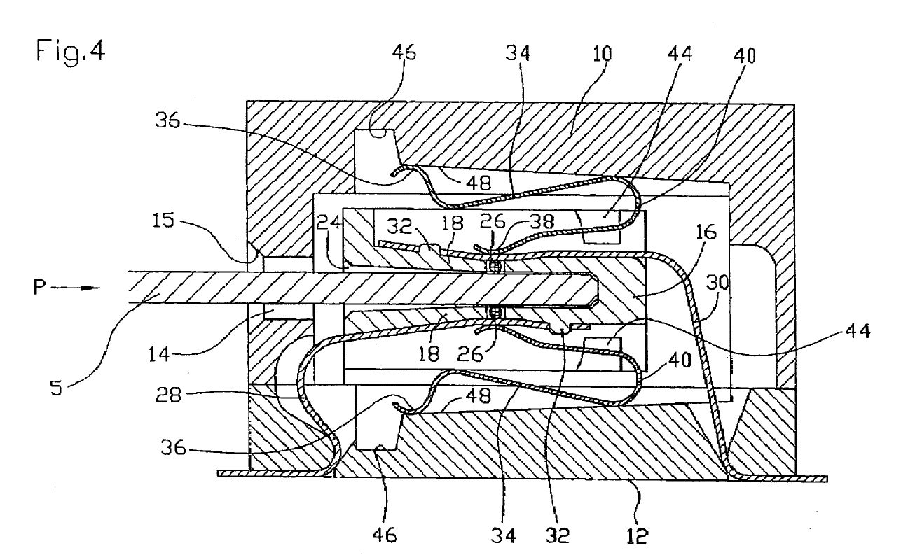

As soon as the plug piece 5 rests on the base 22 of the plug piece receptacle 16 and is further pushed into the plug piece, the plug piece receptacle 16 is entrained in the plug-in direction (see arrow P in FIG. 4), whereby the springs 34 will be entrained by the holding projections 44, too. In the process, the abutment ends 36 of the spring 34 are pulled out of the recesses 46 and moved towards inside, whereby the springs 34 are bent. The higher spring tension results in the supporting ends 38 applying a higher force on the conductor foil 28 or 30, this leading to a higher contact force, on the one hand, between the conductor tracks 31 of the conductor foils 28, 30 and the contact elements 26 and, on the other, between the contact elements 26 and the contact areas 9 of the plug piece 5. It is particularly of advantage if this enhanced contact force will act not until there is no relative motion between the contact elements 26 in the plug piece receptacle and the contact areas 9 of the plug piece 5 any more. On the one hand, this facilitates insertion of the plug piece, and on the other band a high friction between the contact elements 26 and the contact areas 9 and a resulting high wear of the contact areas will be prevented.

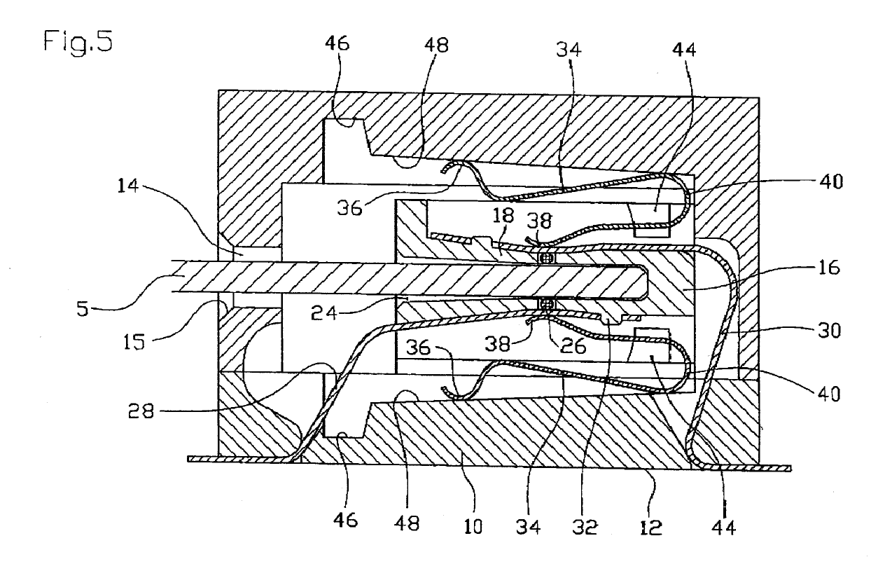

When the plug piece 5 is pushed further into the plug socket, the plug piece receptacle 16 likewise will be pushed into the housing 10, until the plug-in position shown in FIG. 5 is reached. In so doing, the pretension of the spring 34 is further enhanced, because due to the inclined profile of the abutment faces 48 they are pre-tensioned more and more until the maximum contact force will be reached finally, as soon as the plug-in position is reached.

As can be taken from comparing FIGS. 3 to 5, the conductor foils 28, 30 follow the shifting motion of the plug piece receptacle 16 without any problem.

If the plug piece 5 is to be pulled out from the plug socket again, all the steps described for the insertion process will occur in the reverse order. First, the plug piece receptacle 16 together with the plug piece 5 will be brought from the plug-in position shown in FIG. 5 into the initial position shown in FIG. 3, before the plug piece 5 is pulled out of the plug piece receptacle 16. As long as the plug piece receptacle 16 is not in its initial position, the force required for pulling the plug piece 5 out of the plug piece receptacle 16 will be larger than the force required for shifting the plug piece receptacle 16 in the direction towards the initial position. This is due to the fact that the abutment faces 48 are inclined, so that the force acting between the abutment ends 36 and the abutment faces 48 will have a component which biases the springs 34 towards the recesses 46. At the same time there acts a high frictional force between the contact elements 26 and the plug piece 5, because the springs 34 are still under mechanical tension.

1. A plug socket comprising a housing, a plug piece receptacle made of an insulating material and arranged in said housing such that it can be moved between an initial position and a plug-in position, a plurality of contact elements which serve for making contact with a plug piece inserted in said receptacle and are provided on said plug piece receptacle, and at least one spring which urges said plug piece receptacle into said initial position.

2. The plug socket according to claim 1, wherein said plug piece receptacle has side walls and a rectangular cross section and said contact elements are arranged on a broader one of said side walls of said plug piece receptacle.

3. The plug socket according to claim 2, wherein said contact elements are movably arranged in said side wall of said plug piece receptacle.

4. The plug socket according to claim 3, wherein said contact elements are contact balls which are received in a bore in said side wall of said plug piece receptacle.

5. The plug socket according to claim 4, wherein said contact elements are elastically urged towards an interior space of said plug piece receptacle.

6. The plug socket according to claim 5, wherein said spring urging said plug piece receptacle into said initial position also urges said contact elements towards said interior space of said plug piece receptacle.

7. The plug socket according to claim 6, wherein said spring is a U-type spring having an abutment end and a supporting end, said abutment end resting at said housing and said supporting end being supported by said contact elements, so that the latter are urged towards said interior space of said plug piece receptacle.

8. The plug socket according to claim 7, wherein said spring is fastened to said plug piece receptacle, so that said spring is entrained by said plug piece receptacle when the latter is moved from said initial position into said plug-in position.

9. The plug socket according to claim 8, wherein said housing has an abutment face for said abutment end of said spring and wherein said abutment face extends obliquely in relation to a moving direction of said plug piece receptacle, so that said spring is increasingly bent when it is moved, together with said plug piece receptacle, from said initial position into said plug-in position.

10. The plug socket according to claim 9, wherein said abutment face, at its front end as seen in said moving direction of said plug piece receptacle, is provided with a recess which is engaged by said abutment end of said spring if said plug piece receptacle is in said initial position.

11. The plug socket according to claim 1, wherein a flexible conductor foil is arranged between said supporting end of said spring and said contact elements, said conductor foil being fastened to said plug piece receptacle and to said housing as well.

12. The plug socket according to claim 5, wherein said interior space of said plug piece receptacle has an area, situated between an entrance port for said plug piece and said contact elements, which expands towards said entrance port in the nature of a pilot funnel.

13. The plug socket according to claim 1, wherein two springs are provided so as to be arranged on opposite sides of said plug piece receptacle and wherein said plug piece receptacle is mounted between said springs in a floating manner.

14. A plug socket comprising a housing, a plug piece receptacle made of an insulating material, a plurality of contact elements accommodated in said receptacle, said receptacle being movable within said housing, in particular in a floating manner, such that said receptacle properly aligns upon insertion of a plug piece despite any positional tolerances.
